(19) United States
(12) Patent Application Publication
(10) Pub. No.: US 2025/0118852 A1
(43) Pub. Date: Apr. 10, 2025

(54) BATTERY ARRAYS WITH MULTI-PIECE DIVIDING WALL STRUCTURES

(71) Applicant: FORD GLOBAL TECHNOLOGIES, LLC, Dearborn, MI (US)

(72) Inventors: David STEIN, Ann Arbor, MI (US); Vernon Eric JACKSON, Ypsilanti, MI (US); Ian Kenneth McEACHERN, Allen Park, MI (US); Scott M. ROLLINS, Highland, MI (US); Liam E. WEST, Ferndale, MI (US); David DOMAN, Canton, MI (US); Dominic Mario BERTOLINI, Birmingham, MI (US)

(21) Appl. No.: 18/483,732

(22) Filed: Oct. 10, 2023

(51) Int. Cl. H01M 50/291; H01M 10/625; H01M 10/647; H01M 10/6562; H01M 10/658; H01M 50/211; H01M 50/249; H01M 50/293; H01M 50/507

(52) U.S. Cl. CPC H01M 50/291; H01M 10/625; H01M 10/647; H01M 10/6562; H01M 10/658; H01M 50/211; H01M 50/249; H01M 50/293; H01M 50/507; H01M 2220/20

(57) ABSTRACT

Battery arrays are provided for traction battery packs. An exemplary battery array may include a first cell stack subassembly including a first split dividing wall member, and a second cell stack subassembly including a second split dividing wall member. The first split dividing wall member and the second split dividing wall member cooperate to establish a dividing wall assembly between the first cell stack subassembly and the second cell stack subassembly. The dividing wall assembly can function to both provide the necessary tensile structure for maintaining battery cell compression and thermally isolate the adjacent cell stack subassemblies from one another.

### TECHNICAL FIELD

This disclosure relates generally to traction battery packs, and more particularly to battery arrays that include multi-piece dividing wall structures located between adjacent cell stack subassemblies.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a first cell stack subassembly including a first split dividing wall member and a second cell stack subassembly including a second split dividing wall member. The first split dividing wall member nests together with the second split dividing wall member to establish a dividing wall assembly between the first cell stack subassembly and the second cell stack subassembly.

In a further non-limiting embodiment of the foregoing battery array, the first cell stack subassembly includes a first plurality of battery cells stacked between the first split dividing wall member and a first tension plate and further between a first pair of end plates.

In a further non-limiting embodiment of either of the foregoing battery arrays, the second cell stack subassembly includes a second plurality of battery cells stacked between the second split dividing wall member and a second tension plate and further between a second pair of end plates.

In a further non-limiting embodiment of any of the foregoing battery arrays, a bus bar module is arranged between the first split dividing wall member and the first plurality of battery cells.

In a further non-limiting embodiment of any of the foregoing battery arrays, a first protrusion of the first split dividing wall member engages a first channel of the second split dividing wall member.

In a further non-limiting embodiment of any of the foregoing battery arrays, a second protrusion of the second split dividing wall member engages a second channel of the first split dividing wall member.

In a further non-limiting embodiment of any of the foregoing battery arrays, each of the first split dividing wall member and the second split dividing wall member includes a first side having a plurality of ribbed structures and a second side having at least one channel and at least one protrusion.

In a further non-limiting embodiment of any of the foregoing battery arrays, the dividing wall assembly establishes a center wall of the battery array.

In a further non-limiting embodiment of any of the foregoing battery arrays, an air gap extends between the first split dividing wall member and the second split dividing wall member.

In a further non-limiting embodiment of any of the foregoing battery arrays, the first split dividing wall member and the second split dividing wall member are each made of a glass-filled thermoplastic material.

A battery array for a traction battery pack according to another exemplary aspect of the present disclosure includes, among other things, a first cell stack subassembly, a second cell stack subassembly, a dividing wall assembly located between the first cell stack subassembly and the second cell stack subassembly, and an outer array housing that surrounds the first cell stack subassembly, the second cell stack subassembly, and the dividing wall assembly.

In a further non-limiting embodiment of the foregoing battery array, the outer array housing is established by a top plate, a bottom plate, a first pair of end plates of the first cell stack subassembly, a second pair of end plates of the second cell stack subassembly, a first tension plate of the first cell stack subassembly, a second tension plate of the second cell stack subassembly, a first split dividing wall member of the first cell stack subassembly, and a second split dividing wall member of the second cell stack subassembly.

In a further non-limiting embodiment of either of the foregoing battery arrays, the first split dividing wall member and the second split dividing wall member cooperate to establish the dividing wall assembly.

In a further non-limiting embodiment of any of the foregoing battery arrays, a first split dividing wall member of the first cell stack subassembly nests together with a second split dividing wall member of the second cell stack subassembly to establish the dividing wall assembly.

In a further non-limiting embodiment of any of the foregoing battery arrays, a first protrusion of the first split dividing wall member engages a first channel of the second split dividing wall member.

In a further non-limiting embodiment of any of the foregoing battery arrays, a second protrusion of the second split dividing wall member engages a second channel of the first split dividing wall member.

In a further non-limiting embodiment of any of the foregoing battery arrays, each of the first split dividing wall member and the second split dividing wall member includes a first side having a plurality of ribbed structures and a second side having at least one channel and at least one protrusion.

In a further non-limiting embodiment of any of the foregoing battery arrays, an air gap extends between the first split dividing wall member and the second split dividing wall member.

In a further non-limiting embodiment of any of the foregoing battery arrays, the first split dividing wall member and the second split dividing wall member are each made of a glass-filled thermoplastic material.

In a further non-limiting embodiment of any of the foregoing battery arrays, the dividing wall assembly establishes a center wall of the battery array.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 illustrates the battery array of FIG. 2 with portions removed for illustrating select internal components of the battery array.

FIG. 4 is an exploded view of the battery array shown in FIG. 3.

FIG. 5 is a plan view of a cell stack subassembly of the battery array of FIGS. 2-4.

FIG. 6 is a top view of a dividing wall assembly of the battery array of FIGS. 2-4.

### DETAILED DESCRIPTION

This disclosure details battery arrays for traction battery packs. An exemplary battery array may include a first cell stack subassembly including a first split dividing wall member, and a second cell stack subassembly including a second split dividing wall member. The first split dividing wall member and the second split dividing wall member cooperate to establish a dividing wall assembly between the first cell stack subassembly and the second cell stack subassembly. The dividing wall assembly can function to both provide the necessary tensile structure for maintaining battery cell compression and thermally isolate the adjacent cell stack subassemblies from one another. These and other features are discussed in greater detail in the following paragraphs of this detailed description.

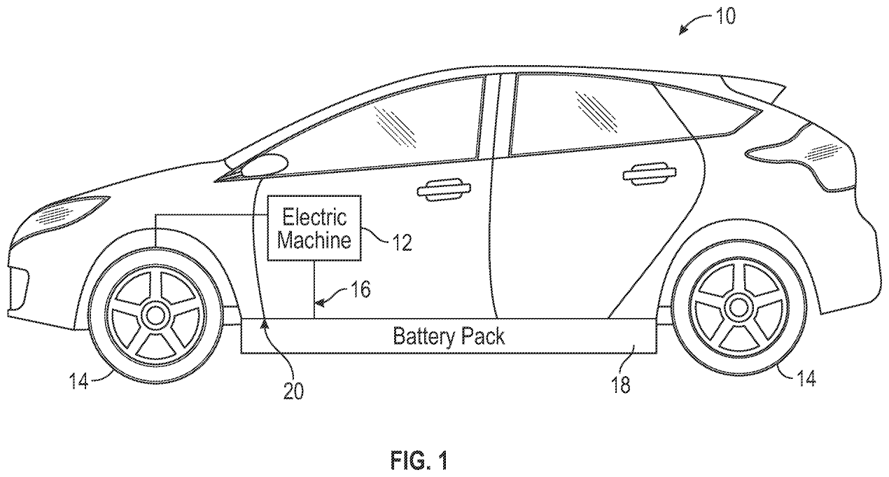

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

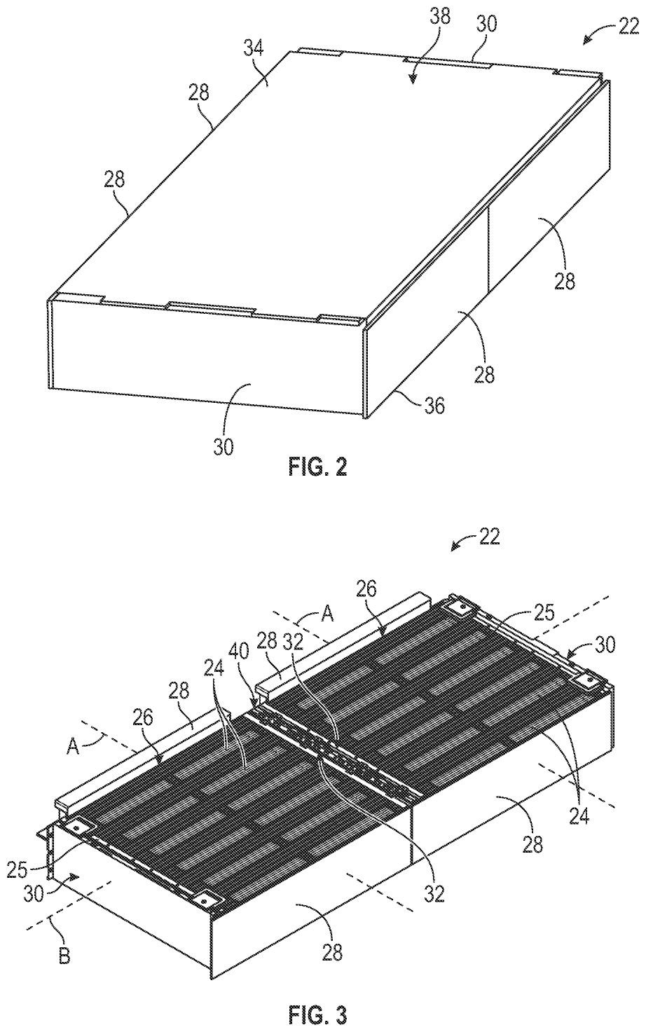

FIGS. 2, 3, and 4 illustrate an exemplary battery array 22 for a traction battery pack, such as the traction battery pack 18 of FIG. 1, for example. One or more battery arrays having a design similar to the battery array 22 shown in FIGS. 2-4 could be packaged within the traction battery pack 18.

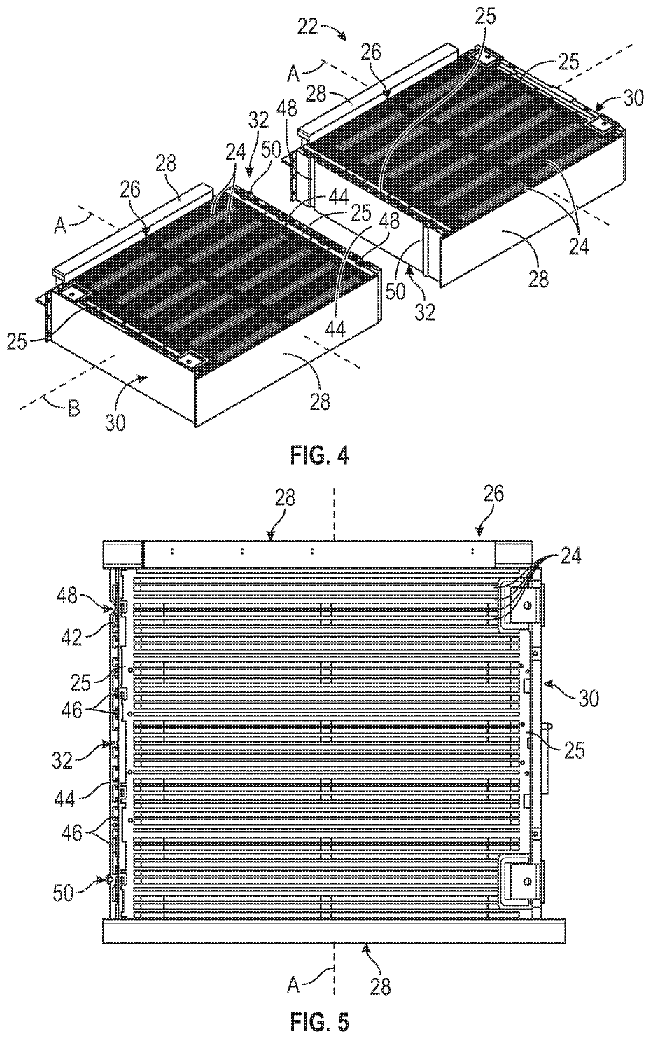

The battery array 22 may include a plurality of battery cells 24 (see FIGS. 3-4). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

The battery cells 24 may be grouped together in one or more cell stack subassemblies 26 that are each arranged to extend along a respective stack axis A. In the illustrated embodiment, the battery array 22 includes two cell stack subassemblies 26. However, a greater or fewer number of cell stack subassemblies 26 could be provided within the battery array 22 within the scope of this disclosure. In an embodiment, the stack axes A are transverse to a longitudinal axis B of the battery array 22. However, other configurations are possible.

The battery cells 24 of each cell stack subassembly 26 may be electrically connected by a pair of bus bar modules 25. Each bus bar module 25 may include a plurality of bus bars (not shown) that may be joined to tab terminals (not shown) of the battery cells 24 for electrically connecting the battery cells 24 to one another. Once electrically coupled, the battery cells 24 may supply electrical power necessary for achieving electric propulsion of the electrified vehicle 10.

The battery cells 24 (and bus bar modules 25) of each cell stack subassembly 26 may stacked between a pair of end plates 28 along the direction of the stack axis A. The battery cells 24 (and bus bar modules 25) of each cell stack subassembly 26 may also be stacked between a tension plate 30 and a split dividing wall member 32 along a direction that is transverse to the stack axis A. The battery cells 24 may be held in compression between the end plates 28 and between the tension plate 30 and the split dividing wall member 32, thereby eliminating the need for compression fixtures when assembling the battery array 22. When the battery array 22 is fully assembled, the bus bar modules 25 may be sandwiched between the battery cells 24 and the tension plates 30 and between the battery cells 24 and the split dividing wall members 32.

The end plates 28, the tension plates 30, a top plate 34, and a bottom plate 36 may cooperate to establish an outer array housing 38 of the battery array 22. The outer array housing 38 may be arranged to substantially surround the various battery internal components of the battery array 22. Two or more of the top plate 34, the bottom plate 36, the end plates 28, and the tension plates 30 may be formed together as a single piece to reduce parts and complexity. For example, the bottom plate 36 and the tension plates 30 may be formed together for establishing a U-shaped structure that covers the ends and bottom of the battery array 22. However, other configurations are contemplated within the scope of this disclosure.

The split dividing wall member 32 of one of the cell stack subassemblies 26 may cooperate with the split dividing wall member 32 of a neighboring cell stack subassembly 26 to establish a dividing wall assembly 40 (see FIG. 3) of the battery array 22. The dividing wall assembly 40 may separate and thermally isolate the cell stack subassemblies 26 from one another. The split dividing wall members 32 may interlock or nest together as one of the cell stack subassemblies 26 is moved into place adjacent to another of the cell stack subassemblies 26 during assembly of the battery array 22.

In the illustrated embodiment, the dividing wall assembly 40 is positioned at or near the center of the battery array 22 and may therefore be considered to provide a center wall of the battery array 22. However, the dividing wall assembly 40 could be located elsewhere along the length of the battery array 22, such as when the battery array 22 includes greater than two cell stack subassemblies 26, for example.

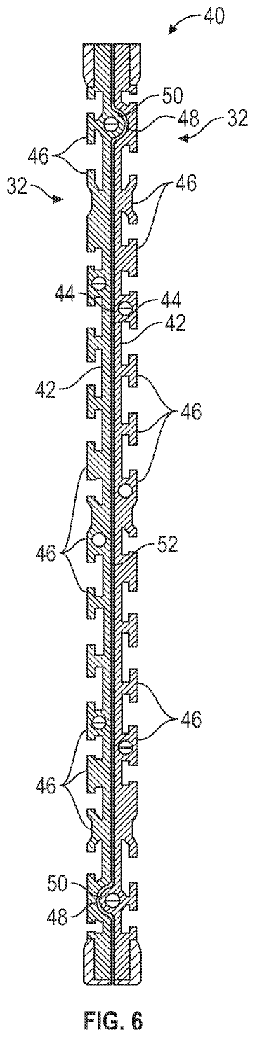

Referring now primarily to FIGS. 4, 5, and 6 (with continued reference to FIGS. 1-3), each split dividing wall member 32 may include a first side 42 that faces toward the battery cells 24 of the respective cell stack subassembly 26 and a second side 44 that faces in a direction toward the split dividing wall member 32 of the neighboring cell stack subassembly 26. A plurality of ribbed structures 46 may protrude outwardly from the first side 42. The ribbed structures 46 may increase the strength and stiffness of the split dividing wall member 32, thus providing the tensile structure necessary for maintaining compression on the battery cells 24 of each cell stack subassembly 26.

The second side 44 of each split dividing wall member 32 may include one or more channels 48 and one or more protrusions 50. The channels 48 may be sized and shaped to receive the protrusions 50 of the neighboring split dividing wall member 32, and the protrusions 50 may be sized and shaped to engage the channels 48 of the neighboring split dividing wall member 32. The split dividing wall members 32 are thereby capable of interlocking/nesting together to form the dividing wall assembly 40 during assembly of the battery array 22.

The split dividing wall members 32 may be designed to interlock with one another in a manner that establishes an air gap 52 therebetween. The air gap 52 can increase the thermal resistance and slow heat transfer between the neighboring cell stack subassemblies 26 within the battery array 22.

Each split dividing wall member 32 may be made from a material that is capable of providing a desired level of tensile strength while also providing electrically insulative qualities. In an embodiment, the split dividing wall members 32 are constructed of glass-filled Polyamide (GF PA6) or long glass-filled polypropylene (LGPP). However, other materials may be suitable within the scope of this disclosure.

The exemplary battery arrays of this disclosure include dividing wall assemblies that separate adjacent cell stack subassemblies from one another. The dividing wall assemblies may be established by interlocking or nesting split dividing wall members that can function to both provide the necessary tensile structure for maintaining battery cell compression and thermally isolate the cell stack subassemblies from one another.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a first cell stack subassembly including a first split dividing wall member; and
a second cell stack subassembly including a second split dividing wall member,
wherein the first split dividing wall member nests together with the second split dividing wall member to establish a dividing wall assembly between the first cell stack subassembly and the second cell stack subassembly.

2. The battery array as recited in claim 1, wherein the first cell stack subassembly includes a first plurality of battery cells stacked between the first split dividing wall member and a first tension plate and further between a first pair of end plates.

3. The battery array as recited in claim 2, wherein the second cell stack subassembly includes a second plurality of battery cells stacked between the second split dividing wall member and a second tension plate and further between a second pair of end plates.

4. The battery array as recited in claim 2, comprising a bus bar module arranged between the first split dividing wall member and the first plurality of battery cells.

5. The battery array as recited in claim 1, wherein a first protrusion of the first split dividing wall member engages a first channel of the second split dividing wall member.

6. The battery array as recited in claim 5, wherein a second protrusion of the second split dividing wall member engages a second channel of the first split dividing wall member.

7. The battery array as recited in claim 1, wherein each of the first split dividing wall member and the second split dividing wall member includes a first side having a plurality of ribbed structures and a second side having at least one channel and at least one protrusion.

8. The battery array as recited in claim 1, wherein the dividing wall assembly establishes a center wall of the battery array.

9. The battery array as recited in claim 1, comprising an air gap between the first split dividing wall member and the second split dividing wall member.

10. The battery array as recited in claim 1, wherein the first split dividing wall member and the second split dividing wall member are each comprised of a glass-filled thermoplastic material.

11. A battery array for a traction battery pack, comprising:
a first cell stack subassembly;
a second cell stack subassembly;
a dividing wall assembly located between the first cell stack subassembly and the second cell stack subassembly; and
an outer array housing that surrounds the first cell stack subassembly, the second cell stack subassembly, and the dividing wall assembly.

12. The battery array as recited in claim 11, wherein the outer array housing is established by a top plate, a bottom plate, a first pair of end plates of the first cell stack subassembly, a second pair of end plates of the second cell stack subassembly, a first tension plate of the first cell stack subassembly, a second tension plate of the second cell stack subassembly, a first split dividing wall member of the first cell stack subassembly, and a second split dividing wall member of the second cell stack subassembly.

13. The battery array as recited in claim 12, wherein the first split dividing wall member and the second split dividing wall member cooperate to establish the dividing wall assembly.

14. The battery array as recited in claim 11, wherein a first split dividing wall member of the first cell stack subassembly nests together with a second split dividing wall member of the second cell stack subassembly to establish the dividing wall assembly.

15. The battery array as recited in claim 14, wherein a first protrusion of the first split dividing wall member engages a first channel of the second split dividing wall member.

16. The battery array as recited in claim 15, wherein a second protrusion of the second split dividing wall member engages a second channel of the first split dividing wall member.

17. The battery array as recited in claim 14, wherein each of the first split dividing wall member and the second split dividing wall member includes a first side having a plurality of ribbed structures and a second side having at least one channel and at least one protrusion.

18. The battery array as recited in claim 14, comprising an air gap between the first split dividing wall member and the second split dividing wall member.

19. The battery array as recited in claim 14, wherein the first split dividing wall member and the second split dividing wall member are each comprised of a glass-filled thermoplastic material.

20. The battery array as recited in claim 11, wherein the dividing wall assembly establishes a center wall of the battery array.
